(19) United States
(12) Patent Application Publication
(10) Pub. No.: US 2025/0290623 A1
(43) Pub. Date: Sep. 18, 2025

(54) LINEAR LIGHT UNIT INCLUDING INTEGRAL ELECTRICAL CONNECTORS FOR CONNECTING TWO LIGHTING TRACK SEGMENTS

(71) Applicant: Diem GmbH, Graz (AT)

(72) Inventors: Stefan Krotmeier, New York, NY (US); Moritz Gessner, Graz (AT)

(21) Appl. No.: 18/606,100

(22) Filed: Mar. 15, 2024

(51) Int. Cl. F21V 23/06; F21S 2/00; F21S 4/28; F21S 8/06; H01R 12/70; H01R 13/512; H01R 13/627; H01R 13/66; H01R 31/06; H01R 43/26

(52) U.S. Cl. CPC F21V 23/06; F21S 2/005; F21S 4/28; F21S 8/066; H01R 13/6273; H01R 13/665; H01R 31/06; H01R 43/26; F21V 21/35; H01R 12/7047; H01R 13/512

(57) ABSTRACT

A linear light assembly is for electrically connecting a first lighting track segment and a second lighting track segment of a lighting track to each other. The linear light assembly includes at least one linear light body including at least one light source for directing light away from the lighting track; a first electrical connector mechanically fixed to the at least one linear light body and configured for being inserted into the first lighting track segment; and a second electrical connector mechanically fixed to the at least one linear light body and configured for being inserted into the second lighting track segment. The first electrical connector and the second electrical connector are configured to transmit power from the power rails of the first lighting track segment to the power rails of the second lighting track segment when the linear light assembly is inserted into the first lighting track segment and the second lighting track segment.

The present disclosure relates generally to track mounted linear light assemblies.

### BACKGROUND

It is known to insert linear lights into lighting tracks and to connect separate track segments.

### SUMMARY

A linear light assembly is provided for electrically connecting a first lighting track segment and a second lighting track segment of a lighting track to each other, the first and second lighting track segments each including walls including a base wall and two side walls extending away from the base wall, at least one of the walls of each of the first and second lighting track segments including power rails for supplying power to the linear light assembly when the linear light assembly is received in the lighting track, the linear light assembly including: at least one linear light body including at least one light source for directing light away from the lighting track; a first power adapter mechanically fixed to the at least one linear light body and electrically connected to the at least one light source, the first power adapter configured for being inserted into the first lighting track segment and including contacts for electrically connecting to the power rails of the first lighting track segment, the first power adapter including a first electrically insulating adapter casing and first electrical adapter contacts for electrically connecting to the power rails of the first lighting track segment; a first electrical connector mechanically fixed to the at least one linear light body, the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment; and a second electrical connector mechanically fixed to the at least one linear light body, the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment, the first electrical connector and the second electrical connector being configured to transmit power from the power rails of the first lighting track segment to the power rails of the second lighting track segment when the linear light assembly is inserted into the first lighting track segment and the second lighting track segment.

A track lighting assembly is also provided that includes a first lighting track segment and a second lighting track segment of a lighting track, the first and second lighting track segments each including walls including a base wall and two side walls extending downward from the base wall; and a linear light assembly for electrically connecting to the first lighting track segment and the second lighting track segment, at least one of the walls of each of the first and second lighting track segments including power rails for supplying power to the linear light assembly when the linear light assembly is received in the lighting track, the linear light assembly including: at least one linear light body including at least one light source for directing light away from the lighting track; a first power adapter mechanically fixed to the at least one linear light body and electrically connected to the at least one light source, the first power adapter configured for being inserted into the first lighting track segment and including contacts for electrically connecting to the power rails of the first lighting track segment, the first power adapter including a first electrically insulating adapter casing and first electrical adapter contacts extending outside of the first electrically insulating adapter casing for electrically connecting to the power rails of the first lighting track segment; a first electrical connector mechanically fixed to the at least one linear light body, the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment; and a second electrical connector mechanically fixed to the at least one linear light body, the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment, the first electrical connector and the second electrical connector being configured to transmit power from the power rails of the first lighting track segment to the power rails of the second lighting track segment when the linear light assembly is inserted into the first lighting track segment and the second lighting track segment.

A method of constructing a linear light assembly for electrically connecting a first lighting track segment and a second lighting track segment of a lighting track to each other is also provided. The first and second lighting track segments each include walls including a base wall and two side walls extending away from the base wall, and at least one of the walls of each of the first and second lighting track segments including power rails for supplying power to the linear light assembly when the linear light assembly is received in the lighting track. The method includes mechanically fixing a first power adapter, a first electrical connector and a second electrical connector to at least one linear light body, the at least one linear light body including at least one light source for directing light away from the lighting track; electrically connecting the first power adapter to the at least one light source; and electrically connecting the first electrical connector and the second electrical connector to each other, the first power adapter configured for being inserted into the first lighting track segment and including contacts for electrically connecting to the power rails of the first lighting track segment, the first power adapter including a first electrically insulating adapter casing and first electrical adapter contacts for electrically connecting to the power rails of the first lighting track segment, the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment, the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment, the first electrical connector and the second electrical connector being configured to transmit power from the power rails of the first lighting track segment to the power rails of the second lighting track segment when the linear light assembly is inserted into the first lighting track segment and the second lighting track segment.

### BRIEF DESCRIPTION OF THE DRAWINGS

The present disclosure is described below by reference to the following drawings, in which:

FIG. 1a shows a perspective view of a track lighting assembly according to a first example of the present disclosure with a linear light assembly spaced apart from a lighting track;

FIG. 1b shows a perspective view of the track lighting assembly shown in FIG. 1a with the linear light assembly inserted inside of lighting track;

FIG. 1c shows an exploded perspective view of the track lighting assembly shown in Fig. la;

FIG. 1d shows a longitudinal view of a power adapter on a linear light body of the track lighting assembly shown in FIG. 1a;

FIG. 1e illustrates one of the ends of a housing base of the linear light body;

FIG. 1f illustrates two or more circuit board segments that are connected together at the longitudinal ends thereof by a fastener;

FIG. 1g illustrates an exploded view of a first electrical connector, a second electrical connector and a cable assembly;

FIG. 1h shows an exploded view of the first power adapter;

FIG. 1i shows an exploded view of the mechanical adapter 50;

FIG. 1j shows a longitudinally facing view of the linear light assembly inserted into the lighting track 12;

FIG. 2a shows a perspective view of a track lighting assembly according to a second example of the present disclosure with a linear light assembly spaced apart from a lighting track;

FIG. 2b shows the linear light assembly in a partially assembled configuration; and

FIG. 2c shows the linear light assembly in an assembled configuration.

### DETAILED DESCRIPTION

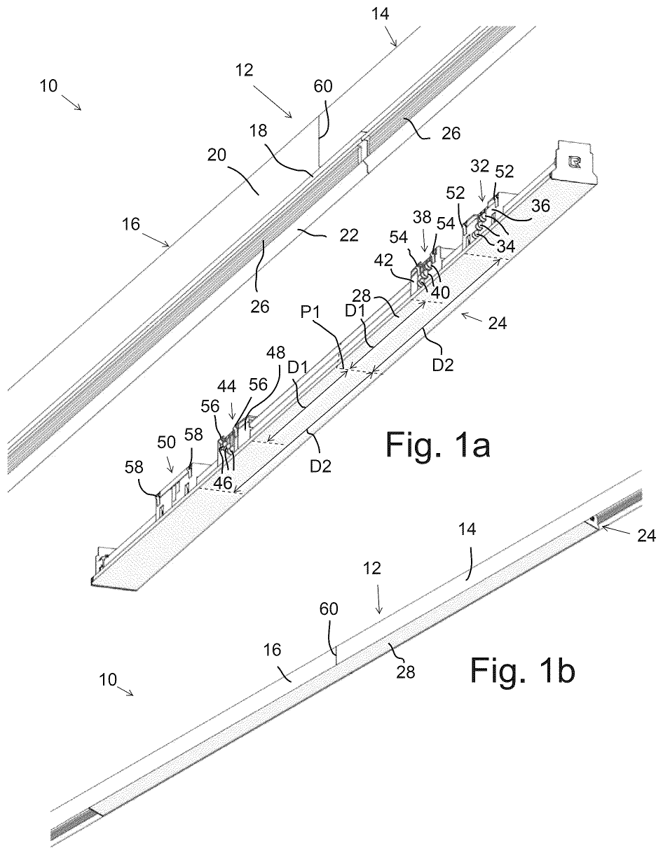

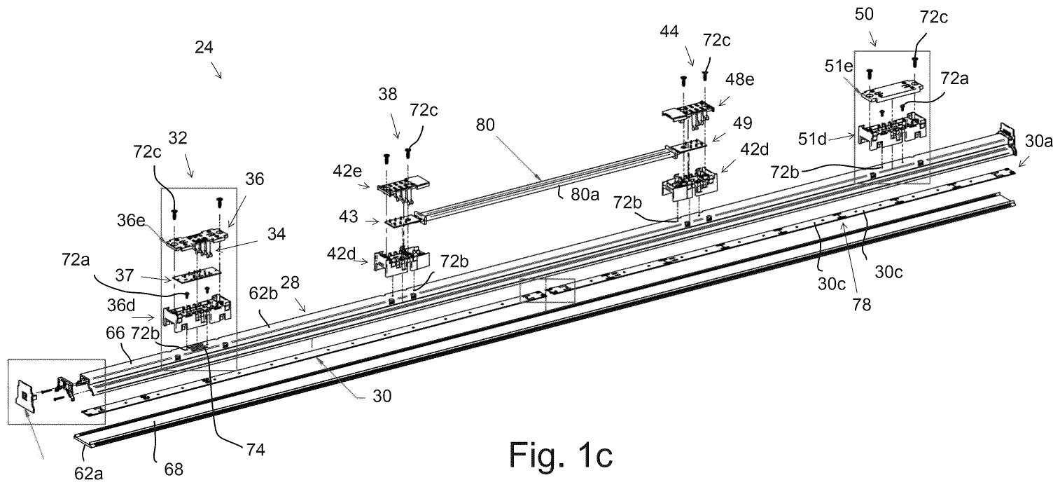

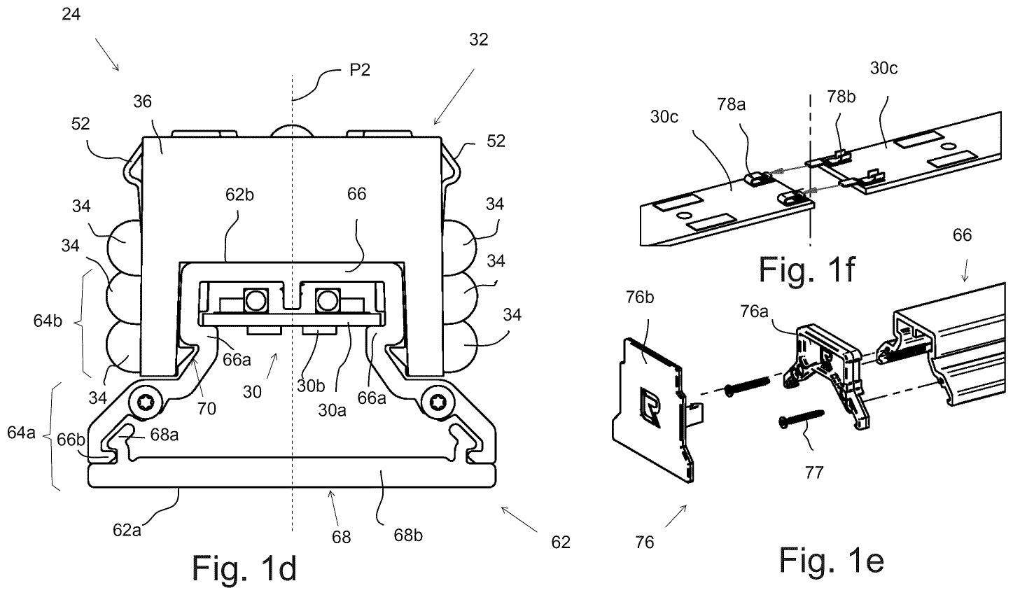

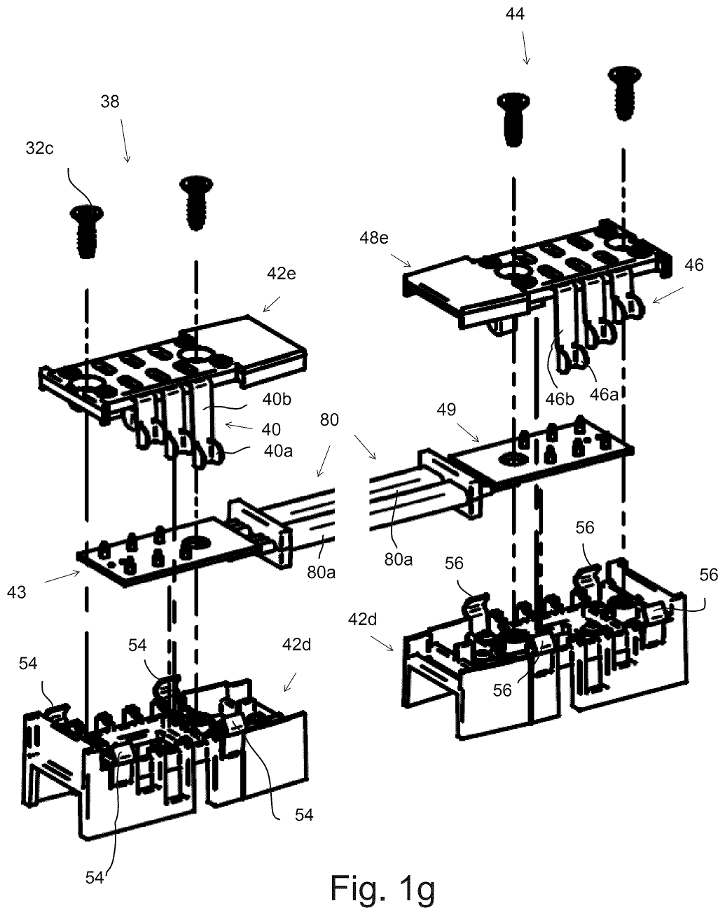

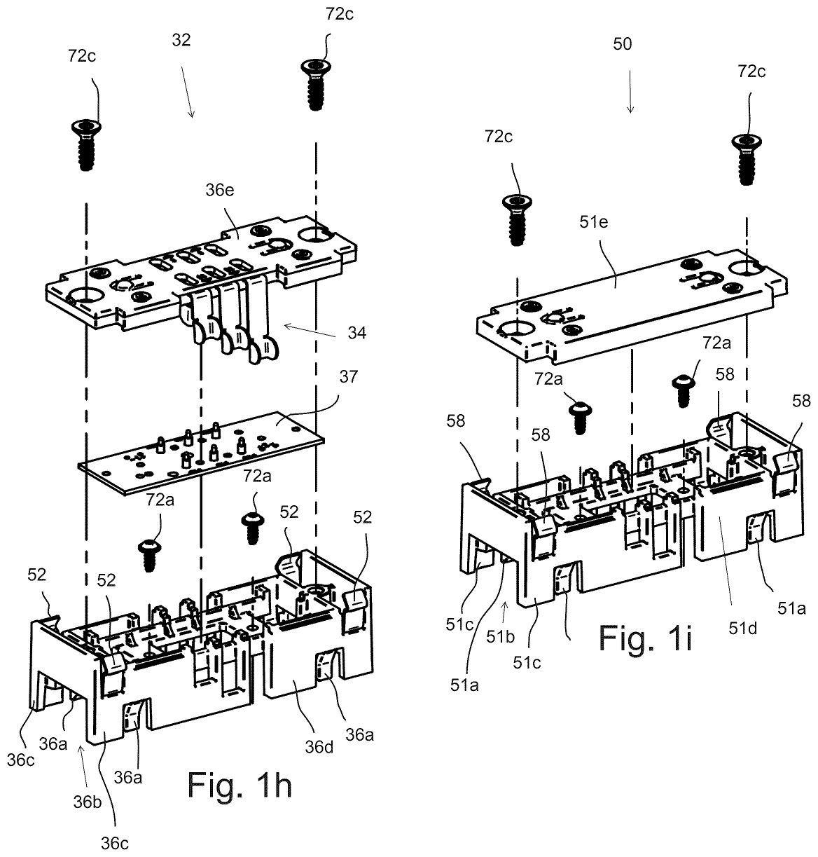

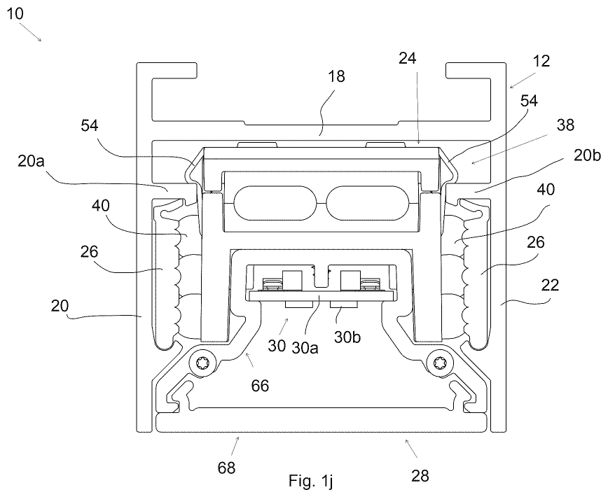

FIGS. 1a, 1b and 1j show a track lighting assembly 10. The track lighting assembly 10 includes a lighting track 12 including a first lighting track segment 14 and a second lighting track segment 16. The first and second lighting track segments 14, 16 each include walls including a base wall 18 and two side walls 20, 22 extending away from the base wall 18. The track lighting assembly 10 also includes a linear light assembly 24 that is configured for being inserted into the first and second lighting track segments 14, 16. FIG. 1a shows linear light assembly 24 spaced apart from lighting track 12, while FIGS. 1b and 1j show linear light assembly 24 inserted inside of lighting track 12.

At least one of the walls 18 to 22 of each of the first and second lighting track segments 14, 16 includes power rails 26 for supplying power to the light assembly 24 when the light assembly 24 is received in the lighting track 12.

The linear light assembly 24 includes a single linear light body 28 including a light source 30 (FIGS. 1c, 1d, 1j) for directing light away from the lighting track 12 when the linear light assembly 24 is inserted into the lighting track 12.

The linear light assembly 24 further includes a first power adapter 32 mechanically fixed to linear light body 28 and electrically connected to the light source 30. The first power adapter 32 is configured for being inserted into the first lighting track segment 14 and including first adapter electrical contacts 34 for electrically connecting to the power rails 26 of the first lighting track segment 14. The first power adapter 32 also includes a first electrically insulating adapter casing 36. The first adapter electrical contacts 34 extend outside of the first electrically insulating adapter casing 36 for electrically connecting to the power rails 26 of the first lighting track segment 14.

The linear light assembly 24 further includes a first electrical connector 38 mechanically fixed to the linear light body 28. The first electrical connector 38 is configured for being inserted into the first lighting track segment 14 and includes first connector electrical contacts 40 for electrically connecting to the power rails 26 of the first lighting track segment 14. The first electrical connector 38 includes a first electrically insulating connector casing 42 and the first connector electrical contacts 40 extend outside of the first electrically insulating connector casing 42 for electrically connecting to the power rails 26 of the first lighting track segment 14.

The linear light assembly 24 further includes a second electrical connector 44 mechanically fixed to the linear light body 28. The second electrical connector 44 is configured for being inserted into the second lighting track segment 16 and includes second connector electrical contacts 46 for electrically connecting to the power rails 26 of the second lighting track segment 16. The second electrical connector 44 includes a second electrically insulating connector casing 48 and the second connector electrical contacts 46 extend outside of the second electrically insulating connector casing 48 for electrically connecting to the power rails 26 of the second lighting track segment 16.

The first electrical connector 38 and the second electrical connector 44 are configured to transmit power from the power rails 26 of the first lighting track segment 14 to the power rails 26 of the second lighting track segment 16 when the linear light assembly 24 is inserted into the first lighting track segment 14 and the second lighting track segment 16.

The linear light assembly 24 further includes a mechanical adapter 50 mechanically fixed to the linear light body 28. The mechanical adapter 50 is configured for being inserted into the second lighting track segment 16. More specifically, the mechanical adapter 50, which includes a casing 51 that is configured in the same manner as casings 36, 42, 48 is configured for being snapped into side walls 20, 22 of the second lighting track segment 16 to removably connect the linear light assembly 24 to the second lighting track segment 16.

Similarly, the first power adapter 32 and the first electrical connector 38 are configured for being snapped into side walls 20, 22 of the first lighting track segment 14 to removably connect the linear light assembly 24 to the first lighting track segment 14. The first power adapter 32 and the first electrical connector 38 together removably connect the linear light assembly 24 to the first lighting track segment 14, with the first power adapter 32 and first electrical connector 38 together bearing the load of the portion of the linear light assembly 24 installed in first lighting track segment 14.

The second electrical connector 44 is also configured for being snapped into side walls 20, 22 of the second lighting track segment 16 to removably connect the linear light assembly 24 to the second lighting track segment 16. The first power adapter 32 and the first electrical connector 38 are configured for being inserted into the first lighting track segment together, and the mechanical adapter 50 and the second electrical connector 44 are configured for being inserted into the second lighting track segment together. The mechanical adapter 50 and the second electrical connector 44 together removably connect the linear light assembly 24 to the second lighting track segment 16, with the mechanical adapter 50 and the second electrical connector 44 together bearing the load of the portion of the linear light assembly 24 installed in second lighting track segment 16.

The linear light assembly 24 is connectable as a unitary structure to both the first lighting track segment 14 and the second lighting track segment 16. In other words, the linear light assembly 24 is fully assembled prior to insertion into the first lighting track segment 14 and second lighting track segment 16. More specifically, the first power adapter 32, the first electrical connector 38, the second electrical connector 44 and mechanical adapter 50 are mechanically fixed to the linear light body 28 prior to insertion of linear light assembly 24 into the first lighting track segment 14 and second lighting track segment 16.

For mechanically connecting to first lighting track segment 14, the first power adapter 32 and the first electrical connector 38 each include respective clips 52, 54 configured for being snapped into side walls 20, 22 of the first lighting track segment 14 to removably connect the linear light assembly 24 to the first lighting track segment 14. Similarly, for mechanically connecting to second lighting track segment 16, the mechanical adapter 50 and the second electrical connector 44 each include clips 56, 58 configured for being snapped into side walls 20, 22 of the second lighting track segment 16 to removably connect the linear light assembly 24 to the second lighting track segment 16.

The linear light assembly 24 is configured such that the first power adapter 32 and the first electrical connector 38 are insertable into the first lighting track segment 14 simultaneous to the mechanical adapter 50 and the second electrical connector 44 being insertable into the second lighting track segment 16.

When installed in lighting track 12, linear light body 28 is configured to overlap a junction 60 between the first lighting track segment 14 and the second lighting track segment 16.

The first electrical connector 38 and the second electrical connector 44 are positioned between the first power adapter 32 and the mechanical adapter 50. The first electrical connector 38 and the second electrical connector 44 are spaced from a longitudinally centered lateral plane P1 of the single linear light body 28 by a first same distance D1, and the first power adapter 32 and the mechanical adapter 50 are spaced from the longitudinally centered lateral plane P1 by a second same distance D2.

As illustrated in FIGS. 1c, 1d and 1f, the linear light body 28 includes a housing 62 surrounding the light source 30. The housing 62 includes a first longitudinally extending surface 62a for facing away from the first and second lighting track segments 14, 16 when the linear light assembly 24 is inserted into the first lighting track segment 14 and the second lighting track segment 16. The first longitudinally extending surface 62a is on a translucent portion of housing 62 for the light source 30 to emit light therethrough. The housing 62 further includes a second longitudinally extending surface 62b for facing toward the base wall 18 of the first and second lighting track segments 14, 16 when the linear light assembly 24 is inserted into the first lighting track segment 14 and the second lighting track segment 16. The first power adapter 32, the first electrical connector 38, the second electrical connector 44 and the mechanical adapter 50 are mounted on the second longitudinally extending surface 62b.

As illustrated in FIG. 1d, the housing 62 includes a first section 64a including the first longitudinally extending surface 62a and a second section 64b including the second longitudinally extending surface 62b. The first section 64a is wider than the second section 64b. The first power adapter 32, first electrical connector 38, the second electrical connector 44 and mechanical adapter 50 are mounted on the second section 64b such that the second section 64b intersects the respective casing 36, 42, 48, 51 of each of first power adapter 32, first electrical connector 38, the second electrical connector 44 and mechanical adapter 50. The first electrical connector 38 and the second electrical connector 44 are wider than the second section 64b. Similarly, the first power adapter 32 and the mechanical adapter 50 are wider than the second section 64b.

As illustrated in FIG. 1d, the first section 64a and the second section 64b are formed by two pieces of housing 62. The first piece is a housing base 66 and the second piece is a translucent cover 68. Housing base 66 and translucent cover 68 together form first section 64a and housing base 66 alone forms second section 64b. More specifically, translucent cover 68 includes surface 62a and housing base 66 includes surface 62b. Housing base 66 and translucent cover 68 are configured such that translucent cover 68 is snappable onto housing base 66. Housing base 66 is hollow and defines an interior space receiving light source 30. Light source 30 can include a support plate in the form of a circuit board 30a and a plurality of light emitting diodes (LEDs) 30b fixed to circuit board 30a in a manner allowing LEDs 30b to emit light through translucent cover 68. Housing base 66 includes two inwardly extending shoulders 66a that extend toward longitudinal extending plane P2 defining a support surface supporting circuit board 30a, allowing circuit board 30a to be installed through an open end of housing base 66 by sliding circuit board 30a along shoulders 66a.

Linear light body 28 also includes wiring 31 inside of housing 62 on an opposite side of circuit board 30a as LEDs 30b. Wiring 31 electrically connects to circuit board 30a to supply current from first power adapter 32 to LEDs 30b. Specifically, wiring 31 passes through hole 74 to control board 37.

Housing base 66 further includes two inwardly extending support ledges 66b defining connectors of housing base 66, which are configured for connecting to connectors of translucent cover 68, which are formed as by flanges 68a of translucent cover 68 that extend from a rectangular base plate 68b of translucent cover 68 away from surface 62a. Translucent cover 68 can be snapped into housing base 66 by pressing translucent cover 68 into housing base 66 so that flanges 68a engage support ledges 66b.

As illustrated in FIGS. 1c, 1d and 1h when considered together, first power adapter 32 can be connected to housing base 66 by pressing casing 36 onto second section 64b such that latches 36a protruding inward into an interior of casing 36 engage with respective grooves 70 defined on sides of housing base 66 on second section 64b. Longitudinal ends of casing 36 each include a notch 36b formed therein for receiving the second section 64b of housing 62, with notch 36b being laterally defined by extensions 36c on opposite lateral sides of casing 36, with second section 64b being received laterally between extensions 36c. Latches 36a are provided on extensions 36c.

More specifically, casing 36 is formed of two distinct pieces that are connectable together. A first piece is a casing base 36d that is connectable to housing 62 first by latches 36a and then by fasteners 72a, and a second piece is a casing cover 36e that is connected to casing base 36d by screwing fasteners 72c through casing cover 36e and into casing base 36d after casing base 36d is connected to housing 62 by fasteners 72a. After casing 36 is connected to housing base 66 by latches 36a, first fasteners 72a can be screwed through holes in casing base 36d and into holes 72b in surface 62b of housing 62 to securely fix casing base 36d to housing 62. First power adapter 32 further includes a control unit in the form of a circuit board 37 inside of casing 36 between casing base 36d and casing cover 36e.

First electrical connector 38, second electrical connector 44 and mechanical adapter 50 are connected to housing base 66 in the same manner as first power adapter 32, with casings 42, 48, 51 each including respective notches 42b, 48b, 51b configurated in the same manner as notches 36b, respective extensions 42c, 48c, 51c configurated in the same manner as extensions 36c, respective casing bases 42d, 48d, 51d configurated in a similar manner as casing base 36d, and respective casing covers 42e, 48e, 51e configurated in a similar manner as casing cover 36e. Casings 42, 48, 51 also each provided with respective latches 42a, 48a, 51a fixed thereto that are configured in the same manner as latches 36a.

In the example shown, first power adapter 32, first electrical connector 38, second electrical connector 44 and mechanical adapter 50 have a few main differences. Only first power adapter 32 is electrically connected to light source 30, while connectors 38, 44 and adapter 50 are not electrically connected to light source 30. In other words, linear light assembly 24 is configured such that first power adapter 32 is configured to provide power to light source 30, and connectors 38, 44 and adapter 50 are configured such that they do not transmit power to light source 30 and no power is transmitted from light source 30 to connectors 38, 44 and adapter 50. As shown in FIG. 1c, housing 62 includes at least one hole 74 in surface 62b of housing base 66 for power cables to pass from first power adapter 32 into housing 62 to power light source 30.

FIG. 1e illustrates one of the ends of housing base 66 illustrating an end cap assembly 76 attached to the ends of housing base 66. After circuit board 30a is slid along shoulders 66a into the interior of housing base 66, end cap assembly 76 can be installed on the end of housing base 66 by screwing an intermediate cap 76a onto housing base 66 via screws 77, then attaching an end 76b onto first portion 76a.

As shown in FIG. 1f, circuit board 30a can be formed of two or more circuit board segments 30c that are connected together at the longitudinal ends thereof by a fastener that includes a first fastener portion 78a fixed to a longitudinal end of one of the two connected circuit board segments 30c and a second fastener portion 78b fixed to a longitudinal end of the other of the two connected circuit board segments 30c.

FIG. 1g illustrates an exploded view of first electrical connector 38, second electrical connector 44 and a cable assembly 80 includes cables 80a electrically connecting the first electrical connector 38 and the second electrical connector 44 and transmitting data from first electrical connector 38 to second electrical connector 44. Connectors 38, 44 are identical.

Each of connectors 38, 44 includes respective clips 54, 56 fixed to and extending laterally outward from upper edges of the respective casing base 42d, 48d. Clips 54, 56 are provided on lateral sides of casings 42, 48, with for example two clips 54, 56 being provided on each of lateral sides of each casing 42, 48. Clips 54, 56 are laterally flexible and are pressed toward casings 42, 48 as clips 54, 56 are being snapped into the track 12.

Electrical contacts 40, 46, in the assembled configuration of connectors 38, 44 are electrically connected to a respective control unit in the form of a circuit board 43, 49. Tabs 40a, 46a of contacts 40, 46 are each fixed to respective bases 40b, 46b that are fixed in electrical contact with the respective circuit board 43, 49. A first circuit includes a first set of electrical contacts 40, 46 on one lateral side of the respective connector 38, 44 and a second circuit is formed by a second set of electrical contacts 40, 46 on the other lateral side of the respective connector 38, 44. Each circuit board 43, 49 is configured for connecting the first set of electrical contacts 40 to the first set of electrical contacts 46 and for connecting the second set of electrical contacts 40 to the second set of electrical contacts 46.

Circuit boards 43, 49 are configured so that, for each set of electrical 40, 46, a first contact is connectable to a positive line, a second contact is connectable to a negative line and a third contact is connectable to a dimming control line. Thus, for example, the short contact of each set of contacts 40, 46 may each be connectable to a respective distinct positive line, the intermediate contact of each set of contacts 40, 46 may each be connectable to a respective distinct negative line, and long contact of each set of contacts 40, 46 may each be connectable to a respective distinct dimming control line.

Casing covers 42e, 48e and circuit boards 43, 49 are connected to respective casing bases 42d, 48d by fasteners 72a that pass through casing covers 42e, 48e and circuit boards 43, 49.

When linear light assembly 24 is connected to first lighting track segment 14 and second lighting track segment 16, current flows from the power rails 26 (FIG. 1a) of the first lighting track segment 14 into contacts 40, next through circuit board 43 into cables 80a to circuit board 49, and then out of contacts 46 into the power rails 26 of the second lighting track segment 16. This then allows the power rails 26 of the second lighting track segment 16 to power a further linear light assembly 24 whose first power adapter 32 is inserted in second lighting track segment 16.

FIG. 1h shows an exploded view of first power adapter 32, illustrating casing cover 36e separated from casing base 36d and the circuit board 37 that is received in casing 36 between casing base 36d and casing cover 36e. Similar to connectors 38, 44, first power adapter 32 includes clips 52 connected to casing base 36d and two sets of electrical contacts 34, each with three contacts of varying heights, connected to casing cover 36e.

FIG. 1i shows an exploded view of mechanical adapter 50, illustrating casing cover 51e separated from casing base 51d. Similar to adaptor 32 and connectors 38, 44, mechanical adapter 50 includes clips 58 connected to casing base 51d. Mechanical adapter 50 is only used for mechanical connection and does not have any electrical function and is not used to transmit power from lighting track 12 to linear light assembly 24 or vice versa.

FIG. 1j shows a longitudinally facing view of the linear light assembly 24 inserted into the lighting track 12, with clips 54 of the first electrical connector 38 connected to side walls 20, 22. Specifically, clips 54 snap into lateral extensions 20a, 22a of side walls 20, 22 such that clips 54 are positioning between lateral extensions 20a, 22a and base wall 18. The first power adapter 32, second electrical connector 44 and mechanical adapter 50 snap into lighting track 12 in the same manner via the respective clips 52, 56, 58.

A method of assembling the track lighting assembly 10 includes moving the linear light assembly 24 into the first lighting track segment 14 and the second lighting track segment 16 to force the first power adapter 32 and the first electrical connector 38 into the first lighting track and cause clips 52 of the first power adapter 32 and clips 54 of the first electrical connector 38 to connect to the side walls 20, 22 of the first lighting track segment 14.

The moving of the linear light assembly 24 into the first lighting track segment 14 and the second lighting track segment 16 also forces the second electrical connector 44 into the second lighting track 16 and cause clips 56 of the second electrical connector 44 to connect to the side walls 20, 22 of the second lighting track 16. The moving of linear light assembly 24 into the first lighting track segment 14 and the second lighting track segment 16 also causes the contacts 34 of the first power adapter 32 and the contacts 40 of the first electrical connector 38 to contact the power rails 26 of the first lighting track segment 14.

The moving of linear light assembly 24 into the first lighting track segment 14 and the second lighting track segment 16 causes the contacts of the second electrical connector 44 to contact the power rails 26 of the second lighting track.

A method of constructing the linear light assembly 24 includes mechanically fixing the first power adapter 32, the first electrical connector 38 and the second electrical connector 44 to linear light body 28. The method also includes electrically connecting the first power adapter 32 to the light source 30, and electrically connecting the first electrical connector 38 and the second electrical connector 44 to each other.

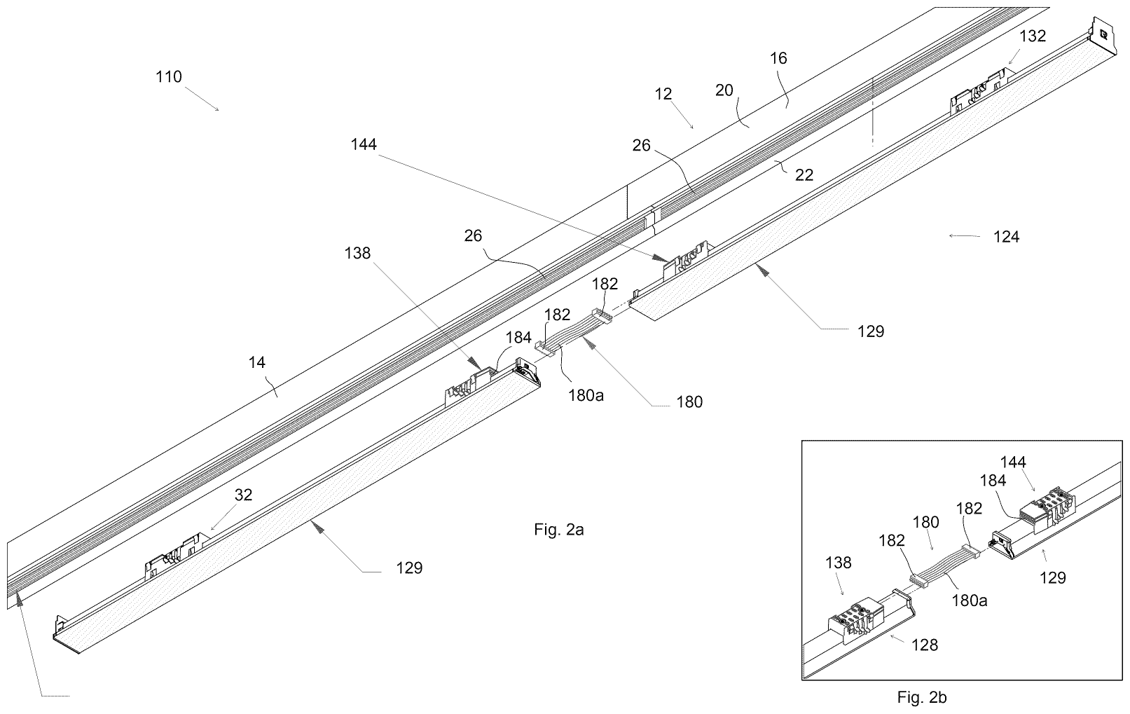

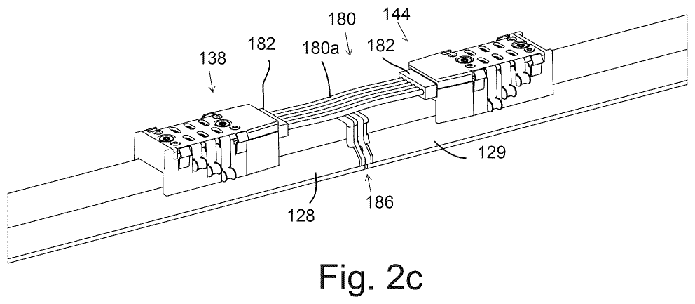

FIGS. 2a and 2b show a track lighting assembly 110 in accordance with another example of the present disclosure. Like track lighting assembly 10, the track lighting assembly 110 includes the lighting track 12 including the first lighting track segment 14 and the second lighting track segment 16. The track lighting assembly 110 also includes a linear light assembly 124 that is configured for being inserted into the first and second lighting track segments 14, 16. FIG. 2a shows linear light assembly 124 spaced apart from lighting track 12.

The linear light assembly 124 includes two linear light bodies-a first linear light body 128 and a second linear light body 129, each including respective a light source 30 (FIG. 1c) for directing light away from the lighting track 12 when the linear light assembly 124 is inserted into the lighting track 12.

On the first linear light body 128, the linear light assembly 124 further includes the same first power adapter 32 as linear light assembly 24 mechanically fixed to the first linear light body 128 and electrically connected to the light source 30 inside the first linear light body 128. The linear light assembly 124 further includes a first electrical connector 138 mechanically fixed to the linear light body 128. The first electrical connector 138 is configured in the exact same manner as first electrical connector 38, except that first electrical connector 138 includes a receptacle 184 for receiving a plug 182 of a cable assembly 180.

On the second linear light body 129, the linear light assembly 124 further includes a second power adapter 132 that is configured in the same manner as first power adapter 32. The second power adapter 132 is mechanically fixed to the second linear light body 129 and electrically connected to the light source 30 inside the second linear light body 129. The linear light assembly 124 further includes a second electrical connector 144 mechanically fixed to the linear light body 129. The second electrical connector 144 is configured in the exact same manner as first electrical connector 138.

The first power adapter 32 and the first electrical connector 138 are configured for being inserted into the first lighting track segment 14 and a second power adapter 132 and second electrical connector 144 are configured for being inserted into second lighting track segment 16.

The first electrical connector 138 and the second electrical connector 144 are configured to transmit power from the power rails 26 of the first lighting track segment 14 to the power rails 26 of the second lighting track segment 16 when the linear light assembly 124 is inserted into the first lighting track segment 14 and the second lighting track segment 16.

The first power adapter 32 and the first electrical connector 138 are configured for being snapped into side walls 20, 22 of the first lighting track segment 14 to removably connect the linear light assembly 124 to the first lighting track segment 14. The first power adapter 32 and the first electrical connector 138 together removably connect the linear light assembly 124 to the first lighting track segment 14, with the first power adapter 32 and first electrical connector 138 together bearing the load of the portion of the linear light assembly 124 installed in first lighting track segment 14.

Similarly, the second power adapter 132 and the second electrical connector 144 are configured for being snapped into side walls 20, 22 of the second lighting track segment 16 to removably connect the linear light assembly 124 to the second lighting track segment 16. The second power adapter 132 and the second electrical connector 144 together removably connect the linear light assembly 124 to the second lighting track segment 16, with the second power adapter 132 and second electrical connector 144 together bearing the load of the portion of the linear light assembly 124 installed in second lighting track segment 16.

Linear light assembly 124 further includes the cable assembly 180, which includes cables 180a electrically connecting the first electrical connector 138 and the second electrical connector 144. Each of the first electrical connector 138 and second electrical connector 144 includes a receptacle 184 for receiving one of the plugs 182 of cable assembly 180. Cables 180a are electrically connected to the first electrical connector 38 by inserting one of plugs 182 in the receptacle 184 of first electrical connector 138 and inserting the other of plugs 182 into the receptacle 184 of second electrical connector 144.

FIG. 2b shows linear light assembly 124 in a partially assembled configuration, with first linear light body 128 and second linear light body 129 spaced apart from each other and with cable assembly 180 detached from first linear light body 128 and second linear light body 129.

FIG. 2c shows linear light assembly 124 in an assembled configuration, with cable assembly 180 attached to first linear light body 128 and second linear light body 129 by plugs 182 of cable assembly 180 being inserted into receptacles 184 of electrical connectors 138, 144.

In the assembled configuration, the longitudinal ends of first linear light body 128 and second linear light body 129 abut each other and the cables 180a extends across an interface 186 at the abutment of the first linear light body 128 and the second linear light body 129.

The cable assembly 180 is long enough to extend across the longitudinal gap between first electrical connector 138 and second electrical connector 144 when ends of linear light bodies 128, 129 abut each other, but short enough that cables 180a do not extend into a plane of the upper surfaces of connectors 138, 144.

The linear light assembly 124 is connectable as a unitary structure to both the first lighting track segment 14 and the second lighting track segment 16. In other words, the linear light assembly 124 is fully assembled prior to insertion into the first lighting track segment 14 and second lighting track segment 16. More specifically, the first power adapter 32 and the first electrical connector 138 are mechanically fixed to the linear light body 128, the second power adapter 132 and the second electrical connector 144 are mechanically fixed to the linear light body 129, and the connectors 138, 144 are electrically connected via cables 180a prior to the insertion of linear light assembly 124 into the first lighting track segment 14 and second lighting track segment 16.

In the preceding specification. The present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

What is claimed is:

1. A linear light assembly for electrically connecting a first lighting track segment and a second lighting track segment of a lighting track to each other, the first and second lighting track segments each including walls including a base wall and two side walls extending away from the base wall, at least one of the walls of each of the first and second lighting track segments including power rails for supplying power to the linear light assembly when the linear light assembly is received in the lighting track, the linear light assembly comprising:
at least one linear light body including at least one light source for directing light away from the lighting track;
a first power adapter mechanically fixed to the at least one linear light body and electrically connected to the at least one light source, the first power adapter configured for being inserted into the first lighting track segment and including contacts for electrically connecting to the power rails of the first lighting track segment, the first power adapter including a first electrically insulating adapter casing and first electrical adapter contacts for electrically connecting to the power rails of the first lighting track segment;
a first electrical connector mechanically fixed to the at least one linear light body, the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment; and
a second electrical connector mechanically fixed to the at least one linear light body, the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment,
the first electrical connector and the second electrical connector being configured to transmit power from the power rails of the first lighting track segment to the power rails of the second lighting track segment when the linear light assembly is inserted into the first lighting track segment and the second lighting track segment.

2. The linear light assembly as recited in claim 1 wherein the first power adapter and/or the first electrical connector are configured for being snapped into mechanical connection with the first lighting track segment to hold the linear light assembly in the first lighting track segment.

3. The linear light assembly as recited in claim 2 wherein the first power adapter and/or the first electrical connector includes clips configured for being snapped into side walls of the first lighting track segment to removably connect the linear light assembly to the first lighting track segment.

4. The linear light assembly as recited in claim 2 wherein both the first power adapter and the first electrical connector are configured for being snapped into mechanical connection with the first lighting track segment to hold the linear light assembly in the first lighting track segment.

5. The linear light assembly as recited in claim 4 wherein both the first power adapter and the first electrical connector include clips configured for being snapped into side walls of the first lighting track segment to removably connect the linear light assembly to the first lighting track segment.

6. The linear light assembly as recited in claim 1 wherein the second electrical connector is configured for being snapped into mechanical connection with the second lighting track segment to hold the linear light assembly in the second lighting track segment.

7. The linear light assembly as recited in claim 1 further comprising a mechanical adapter mechanically fixed to the at least one linear light body,
the mechanical adapter configured for being inserted into the second lighting track segment,
the mechanical adapter configured for being snapped into side walls of the second lighting track segment to removably connect the linear light assembly to the second lighting track segment.

8. The linear light assembly as recited in claim 7 wherein both the mechanical adapter and the second electrical connector are configured for being snapped into mechanical connection with the second lighting track segment to hold the linear light assembly in the second lighting track segment.

9. The linear light assembly as recited in claim 8 wherein both the mechanical adapter and the second electrical connector include clips configured for being snapped into side walls of the second lighting track segment to removably connect the linear light assembly to the second lighting track segment.

10. The linear light assembly as recited in claim 1 further comprising a second power adapter mechanically fixed to the at least one linear light body and electrically connected to the at least one light source, the second power adapter configured for being inserted into the second lighting track segment and including contacts for electrically connecting to the power rails of the second lighting track segment, the second power adapter including a second electrically insulating adapter casing and second electrical adapter contacts extending outside of the second electrically insulating adapter casing for electrically connecting to the power rails of the second lighting track segment.

11. The linear light assembly as recited in claim 10 wherein the second power adapter and/or the second electrical connector are configured for being snapped into mechanical connection with the second lighting track segment to hold the linear light assembly in the second lighting track segment.

12. The linear light assembly as recited in claim 10 wherein both the second power adapter and the second electrical connector are configured for being snapped into mechanical connection with the second lighting track segment to hold the linear light assembly in the second lighting track segment.

13. The linear light assembly as recited in claim 1 wherein the linear light assembly is connectable as a unitary structure to both the first lighting track segment and the second lighting track segment.

14. The linear light assembly as recited in claim 1 wherein the at least one linear light body includes a single linear light body that is configured to overlap a junction between the first lighting track segment and the second lighting track segment.

15. The linear light assembly as recited in claim 14 further comprising at least one cable electrically connecting the first electrical connector and the second electrical connector.

16. The linear light assembly as recited in claim 14 wherein further comprising a mechanical adapter mechanically fixed to the single linear light body,
the mechanical adapter and the second electrical connector being configured for being inserted into the second lighting track segment together,
the first power adapter and the first electrical connector being configured for being inserted into the first lighting track segment together.

17. The linear light assembly as recited in claim 16 wherein the first electrical connector and the second electrical connector are positioned between the first power adapter and the mechanical adapter.

18. The linear light assembly as recited in claim 17 wherein the first electrical connector and the second electrical connector are spaced from a center longitudinal plane of the single linear light body by a first same distance, and the first power adapter and the mechanical adapter are spaced from the center longitudinal plane of the single linear light body by a second same distance.

19. The linear light assembly as recited in claim 16 wherein the linear light assembly is configured such that the first power adapter and the first electrical connector are insertable into the first lighting track segment simultaneous to the mechanical adapter and the second electrical connector being insertable into the second lighting track segment.

20. The linear light assembly as recited in claim 1 wherein the at least one linear light body includes a first linear light body including a first light source and a second linear light body including a second light source,
the linear light assembly further comprising a second power adapter mechanically fixed to the second linear light body and electrically connected to the second light source, the second power adapter configured for being inserted into the second lighting track segment and including contacts for electrically connecting to the power rails of the second lighting track segment, the second power adapter including a second electrically insulating adapter casing and second electrical adapter contacts extending outside of the second electrically insulating adapter casing for electrically connecting to the power rails of the second lighting track segment,
the first power adapter and the first electrical connector being fixed to the first linear light body,
the second electrical connector being fixed to the second linear light body.

21. The linear light assembly as recited in claim 20 further comprising at least one cable electrically connecting the first electrical connector and the second electrical connector.

22. The linear light assembly as recited in claim 21 wherein the first electrical connector includes a first receptacle and the second electrical connector includes a second receptacle,
the at least one cable being electrically connected to the first electrical connector by a first plug insertable into the first receptacle,
the at least one cable being electrically connected to the second electrical connector by a second plug insertable into the second receptacle.

23. The linear light assembly as recited in claim 21 wherein the at least one cable extends across an interface between the first linear light body and the second linear light body.

24. The linear light assembly as recited in claim 20 wherein first linear light body and a second linear light body are identical.

25. The linear light assembly as recited in claim 1 wherein the at least one linear light body includes at least one housing including a first longitudinally extending surface for facing away from the first and second lighting track segments when the linear light assembly is inserted into the first lighting track segment and the second lighting track segment,
the first longitudinally extending surface being translucent for the at least one light source to emit light therethrough,
the at least one housing including a second longitudinally extending surface for facing toward the base wall of the first and second lighting track segments when the linear light assembly is inserted into the first lighting track segment and the second lighting track segment,
the first power adapter, the first electrical connector and the second electrical connector being mounted on the second longitudinally extending surface.

26. The linear light assembly as recited in claim 25 wherein the at least one housing includes a first section including the first longitudinally extending surface and a second section including the second longitudinally extending surface,
the first section being wider than the second section,
the first electrical connector and the second electrical connector being mounted on the second section such that the second section intersects the first electrically insulating connector casing and the second electrically insulating connector casing.

27. The linear light assembly as recited in claim 26 wherein the first electrical connector and the second electrical connector are wider than the second section.

28. A track lighting assembly comprising:
a lighting track including a first lighting track segment and a second lighting track segment, the first and second lighting track segments each including walls including a base wall and two side walls extending downward from the base wall; and
a linear light assembly for electrically connecting to the first lighting track segment and the second lighting track segment, at least one of the walls of each of the first and second lighting track segments including power rails for supplying power to the linear light assembly when the linear light assembly is received in the lighting track, the linear light assembly comprising:
at least one linear light body including at least one light source for directing light away from the lighting track;
a first power adapter mechanically fixed to the at least one linear light body and electrically connected to the at least one light source, the first power adapter configured for being inserted into the first lighting track segment and including contacts for electrically connecting to the power rails of the first lighting track segment, the first power adapter including a first electrically insulating adapter casing and first electrical adapter contacts extending outside of the first electrically insulating adapter casing for electrically connecting to the power rails of the first lighting track segment;
a first electrical connector mechanically fixed to the at least one linear light body, the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment; and
a second electrical connector mechanically fixed to the at least one linear light body, the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment,
the first electrical connector and the second electrical connector being configured to transmit power from the power rails of the first lighting track segment to the power rails of the second lighting track segment when the linear light assembly is inserted into the first lighting track segment and the second lighting track segment.

29. The track lighting assembly as recited in claim 28 wherein the linear light assembly is connectable as a unitary structure to both the first lighting track segment and the second lighting track segment.

30. The track lighting assembly as recited in claim 28 wherein the at least one linear light body includes a single linear light body that is configured to overlap a junction between the first lighting track segment and the second lighting track segment.

31. The track lighting assembly as recited in claim 28 wherein the at least one linear light body includes a first linear light body and a second linear light body,
the linear light assembly further comprising a second power adapter mechanically fixed to and electrically connected to the second linear light body, the second power adapter configured for being inserted into the second lighting track segment and including contacts for electrically connecting to the power rails of the second lighting track segment, the second power adapter including a second electrically insulating adapter casing and second electrical adapter contacts extending outside of the second electrically insulating adapter casing for electrically connecting to the power rails of the second lighting track segment
the first power adapter and the first electrical connector being fixed to the first linear light body,
the second electrical connector being fixed to the second linear light body.

32. A method of assembling the track lighting assembly as recited in claim 28, the method comprising:
moving linear light assembly into the first lighting track segment and the second lighting track segment to force the first power adapter and the first electrical connector into the first lighting track and cause clips of the first power adapter and clips of the first electrical connector to connect to the side walls of the first lighting track, and to force the second electrical connector into the second lighting track and cause clips of the second electrical connector to connect to the side walls of the second lighting track,
the moving of linear light assembly into the first lighting track segment and the second lighting track segment causing the contacts of the first power adapter and the contacts of the first electrical connector to contact the power rails of the first lighting track,
the moving of linear light assembly into the first lighting track segment and the second lighting track segment causing the contacts of the second electrical connector to contact the power rails of the second lighting track.

33. A method of constructing a linear light assembly for electrically connecting a first lighting track segment and a second lighting track segment of a lighting track to each other, the first and second lighting track segments each including walls including a base wall and two side walls extending away from the base wall, at least one of the walls of each of the first and second lighting track segments including power rails for supplying power to the linear light assembly when the linear light assembly is received in the lighting track, the method comprising:
mechanically fixing a first power adapter, a first electrical connector and a second electrical connector to at least one linear light body, the at least one linear light body including at least one light source for directing light away from the lighting track;
electrically connecting the first power adapter to the at least one light source; and
electrically connecting the first electrical connector and the second electrical connector to each other,
the first power adapter configured for being inserted into the first lighting track segment and including contacts for electrically connecting to the power rails of the first lighting track segment, the first power adapter including a first electrically insulating adapter casing and first electrical adapter contacts for electrically connecting to the power rails of the first lighting track segment,
the first electrical connector configured for being inserted into the first lighting track segment and including contacts for electrically connecting to the power rails of the first lighting track segment, the first electrical connector including a first electrically insulating connector casing and first electrical connector contacts extending outside of the first electrically insulating connector casing for electrically connecting to the power rails of the first lighting track segment,
the second electrical connector configured for being inserted into the second lighting track segment and including contacts for electrically connecting to the power rails of the second lighting track segment, the second electrical connector including a second electrically insulating connector casing and second electrical connector contacts extending outside of the second electrically insulating connector casing for electrically connecting to the power rails of the second lighting track segment,
the first electrical connector and the second electrical connector being configured to transmit power from the power rails of the first lighting track segment to the power rails of the second lighting track segment when the linear light assembly is inserted into the first lighting track segment and the second lighting track segment.
